(19) United States
(12) Patent Application Publication
(10) Pub. No.: US 2017/0285961 A1
(43) Pub. Date: Oct. 5, 2017

(54) 3D STACKABLE HYBRID PHASE CHANGE MEMORY WITH IMPROVED ENDURANCE AND NON-VOLATILITY

(71) Applicant: Alibaba Group Holding Limited, George Town (KY)

(72) Inventor: Shu LI, Santa Clara, CA (US)

(21) Appl. No.: 15/091,203

(22) Filed: Apr. 5, 2016

(51) Int. Cl. G06F 3/06

(52) U.S. Cl. CPC G06F 3/0605; G06F 3/061; G06F 3/0616; G06F 3/0659; G06F 3/0679

(57) ABSTRACT

Systems and methods for using PCM to implement a non-volatile memory solution characterized by high density, high capacity, enhanced endurance, and low power consumption are described. The PCM memory solutions described are thousands of time faster than NAND flash memory, and the endurance thereof is improved significantly compared to traditional PCM implementations. The frequency with which data is written to PCM is controlled to extend the useful life of the PCM. This is accomplished using assisting memories such as DRAM and NAND flash, for example, to adjust the time interval between subsequent PCM write operations.

### FIELD

Embodiments of the present invention generally relate to the field of computer memory. More specifically, embodiments of the present invention relate to systems and methods for using Phase Change Memory in a tiered storage system.

### BACKGROUND

Server memory is typically implemented using conventional Dynamic Random-Access Memory (DRAM) due to high endurance characteristic and relatively short access times. However, DRAM is a volatile storage solution that must be refreshed periodically for data retention and suffers from soft errors. Flash is popular for high-performance storage devices but suffers from endurance limitations and much longer read and write times compared to DRAM.

There is a growing need in the field of data storage to replace conventional DRAM and NAND Flash server memory solutions with Phase Change Memory (PCM) to better meet the demands of modern data storage systems. However, PCM suffers from endurance limitations and can only be written to approximately 10⁷ times before the usage must be terminated. DRAM by comparison can be written to 10¹⁴ times during its useful lifetime.

Existing techniques for mitigating the endurance limitations of PCM include wear leveling policies that attempt to write data into PCM cells evenly to avoid some cells terminating earlier than others. However, this solution requires that the memory capacity implemented must be significantly larger than the I/O throughput thereof. Furthermore, the amount of data written to the device during a given time period must be maintained well below the peak throughput of the device. In other words, the performance of the PCM must be reduced significantly to increase the overall lifespan of PCM effectively using existing techniques. What is needed is a method for increasing the endurance of PCM when used as server memory without compromising the performance advantages offered by PCM.

### SUMMARY

Embodiments of the present invention describe systems and methods for using PCM to implement a non-volatile memory solution characterized by high density, high capacity, enhanced endurance, and low power consumption. The PCM memory solutions described are thousands of times faster than NAND flash memory, and the endurance thereof is improved significantly compared to traditional PCM implementations. The frequency with which data is written to PCM is controlled to extend the useful life of the PCM. This is accomplished using assisting memories such as DRAM and NAND flash, for example, to adjust the time interval between subsequent PCM write operations.

According to one embodiment, an exemplary method for storing data using phase change memory is disclosed. The method includes writing the new data to DRAM, merging the new data and with subsequent data to generate a data chunk, dividing the data chunk into a plurality of data slices, calculating a hash value for a data slice of the plurality of data slices, determining if the hash value calculated for the data slice exists in a hash library, writing the data slices to flash memory when the calculated hash value for the respective data slice does not exist in the hash library, and writing the data slices from the flash memory to the phase change memory.

According to another embodiment, an exemplary memory system is disclosed. The memory system includes a memory controller, a first storage tier coupled to the memory controller, comprising DRAM, a second storage tier coupled to the memory controller, comprising flash memory, and a third storage tier coupled to the memory controller, comprising phase change memory. A first data set is written to DRAM. The first data is merged with subsequent data to generate a data chunk, where the data chunk is divided into a plurality of data slices. A hash value is calculated for a data slice of the plurality of data slices, the data slice is written to flash memory when the calculated hash value for the respective data slice does not exist in a hash library, and a plurality of data slices are written from the flash memory to the phase change memory.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram depicting an exemplary multi-tier hybrid memory system with enhanced PCM endurance according to embodiments of the present invention.

FIG. 2 is a flow-chart depicting an exemplary sequence of computer-implemented steps for performing a method of writing data to a three-tier storage system using PCM memory according to embodiments of the present invention.

FIG. 3 is a block diagram depicting an exemplary set of data slices at four different times an according to embodiments of the present invention.

FIG. 4 is a block diagram depicting an exemplary data flow for a memory system operating in a read mode, a write mode, and a power failure mode according to embodiments of the present invention.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

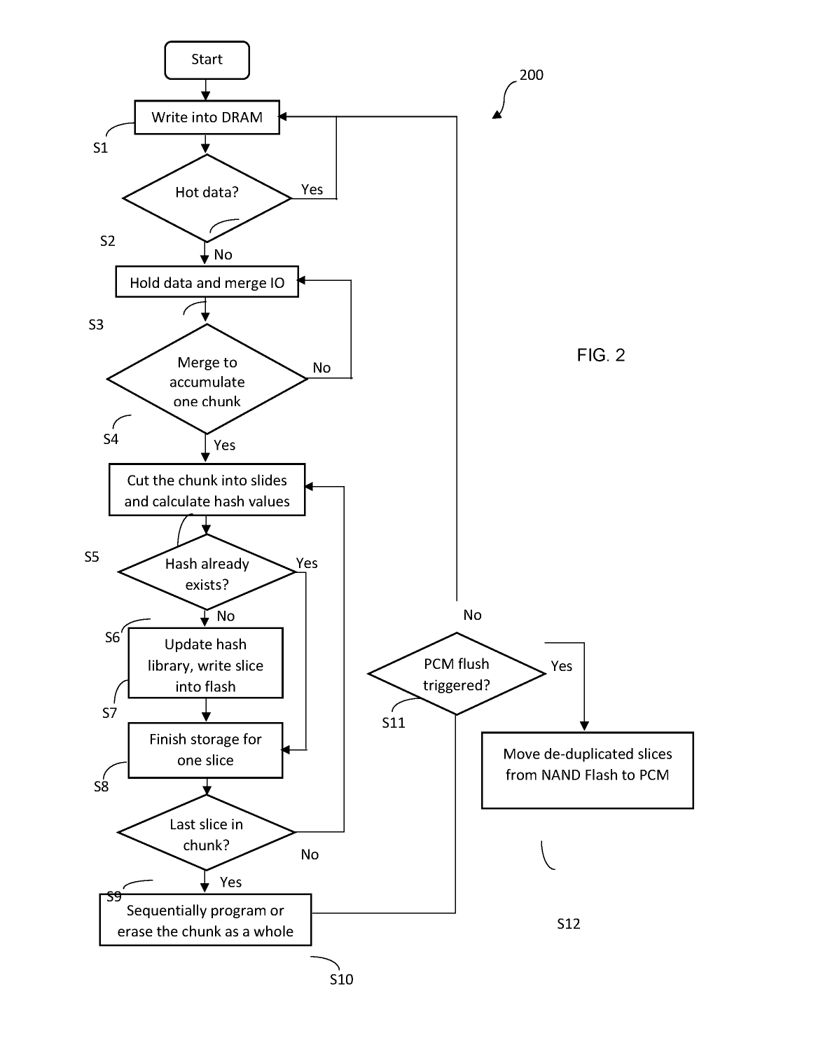

Portions of the detailed description that follows are presented and discussed in terms of a method. Although steps and sequencing thereof are disclosed in a figure herein (e.g., FIG. 2) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### 3D Stackable Hybrid Phase Change Memory with Improved Endurance and Non-Volatility

Embodiments of the present invention describe systems and methods for using PCM to implement a non-volatile memory solution characterized by high density, high capacity, enhanced endurance, and low power consumption. The PCM memory solutions described are thousands of time faster than NAND flash memory, and the endurance thereof is improved significantly compared to traditional PCM implementations. The frequency with which data is written to PCM is controlled to extend the useful life of the PCM. This is accomplished using assisting memories such as DRAM and NAND flash, for example, to adjust the time interval between subsequent PCM write operations.

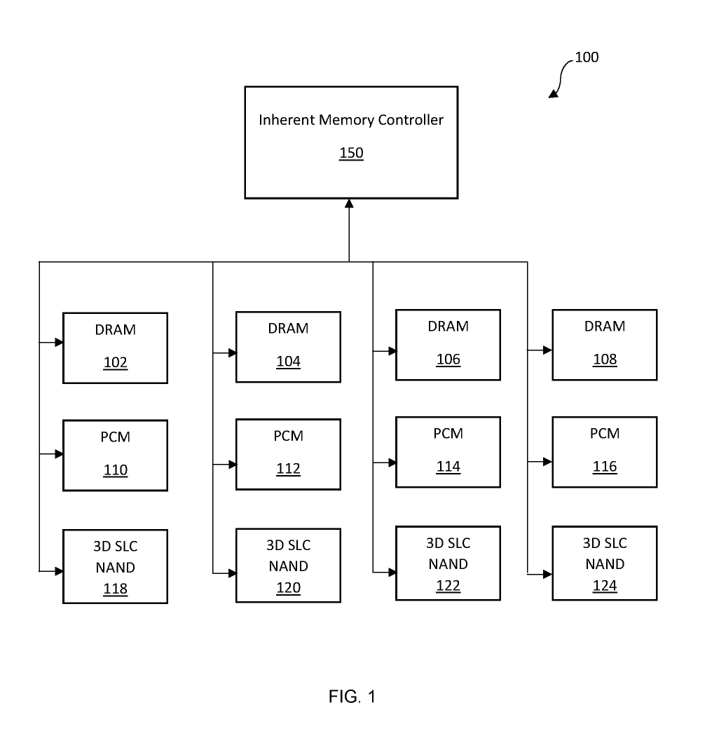

With regard to FIG. 1, an exemplary multi-tier hybrid memory system 100 with enhanced PCM endurance is depicted according to embodiments of the present invention. Certain types of access patterns are observed for various types of data. For example, OS libraries, drivers, system configuration data, comprise data that is almost never updated (e.g., static or almost static data). Such data is generally loaded into memory from a storage drive (e.g., a hard disk drive), and remains in memory while the server is running and is read as necessary. This type of data requires low read latency; however, low write latency is not required. As such, PCM memory is an effective solution for almost static data as the read latency thereof is comparable to that of DRAM.

The memory system 100 has the following characteristics:

1. The effective data amount stored on the memory system at any moment is no greater than the capacity of the PCM memory (e.g., 16 GB).
2. The bandwidth of each transfer is 8 bytes for user data and 9 bytes for overall data.
3. Certain memory locations (e.g., pages) are updated with significantly higher frequency than others.
4. Some pages are loaded into memory once and are read-only (e.g., OS libraries).
5. Virtual machines share common images loaded into memory.

The multi-tier hybrid memory system 100 includes small capacity DRAM 102-108, PCM with a specific storage capacity (e.g., 16 GB) 110-116, 3D SLC NAND flash 118-124 with the same capacity as the PCM, and an inherent memory controller 150. The first level of the cache in the memory system is DRAM 102-108 used to hold data that is frequently updated. Data is written in small amounts to the DRAM 102-108. High-performance computation (HPC) data is one example of data that is updated frequently. In general, the sooner a batch of data is updated, the smaller the batch will be. For example, for a memory that writes 2000 MT/s using a 72-bit data bus consisting of user bits and parity bits, in a worst case scenario, each memory write of 100% new data amounts to approximately 14.4 Mbits over 100 us, which is a very low percentage of the storage capacity (e.g., 0.01% of 16 GB). However, the worst case scenario rarely occurs. As such, approximately 1.6 MB of DRAM is sufficient in most cases.

The DRAM 102-108 is also used to buffer and merge small IOs into multiple NAND blocks (e.g., 16 MB) for writing in serial to flash memory. This improves both NAND endurance and IOPS performance because the sequential write causes the write amplification factor to remain close to 1. As such, an entire NAND block is written at a time, therefore garbage collection methods used to recycle valid pages in a block to be erased is rarely necessary.

Using a sequential series of writes better utilizes the NAND flash channels of 3D NAND 118-124 to more quickly complete write operations. According to some embodiments, the 3D SLC NAND 118-124 is used as a high-bandwidth write cache to provide a non-volatile, high bandwidth, high TOPS, and high storage density storage server. Flash suffers from known endurance issues, specifically, limited P/E cycles. Because the total capacity of the 3D SLC flash memory 118-124 is close to the nominal capacity of the server memory, there is very little room for large amounts of data to be stored on the 3D SLC flash memory 118-124 while implementing wear-leveling. Embodiments of the present invention use NAND flash with floating gates that trap a charge, where the trapped charge alters the threshold voltage of a flash cell used to turn the conduction between the source and the drain in the transistor on and off. The data retention and endurance of the NAND flash are strongly coupled. Over time, the charge trapped in the floating gate leaks away, affecting the data retention of the memory. The configuration of the 3D SLC flash memory 118-124 is adjusted to increase the endurance significantly at the cost of data retention capabilities.

With regard to FIG. 2, a flow-chart 200 depicting an exemplary sequence of computer-implemented steps for performing a method of writing data to a three-tier storage system comprising DRAM, Flash memory, and PCM is illustrated according to embodiments of the present invention. At step S1, data is written into DRAM. If the data is write-intensive (e.g., hot data), updates to the data will be made within the local DRAM, and the process continues to step S11. Otherwise, when the data is not write-intensive, the data is held in DRAM and waits until other peers are grouped together at step S3. Different chunk sizes may be defined for different applications. When sufficient data is held in DRAM, the IOs will be merged at step S4 to accumulate one chunk. Chunk size may be based on 3D SLC NAND Flash programming speed, DRAM utilization, Flash block size, data access patterns, how often data is written from DRAM into 3D SLC NAND Flash, and the amount of real-time data movement, for example.

At step S5, the chunk is divided into slices, and hash values are calculated on-the-fly (e.g., without waiting for an entire chunk to accumulate). Because the data slice may be updated in DRAM, a hash value calculation will be triggered whenever the slice in DRAM is updated or changed. According to some embodiments, a hash value is calculated as soon as the slice is received. When a specific slice already exists in 3D SLC NAND Flash, the metadata is updated without physically writing the slice to flash. The physical address of the existing slice will be pointed to by multiple logical addresses. At step S6, it is determined if the hash value already exists. If so, storage for one slice is completed at step S8. If the has value does not already exist, as step S7, the hash library is updated and the slice is written into flash. Unique slices are written to 3D SLC NAND Flash using a log-structure, where incoming data is appended after the current write pointer. Once the library is updated, step S8 is performed to finish storage for one slice. At step S9, it is determined if storage has been completed for all slices. If not, the process returns to step S5 until all slices have been stored. The process then moves to step S10, where the entire chunk is programmed or erased. At step S11, it is determined if a PCM flush has been triggered. When the PCM flush is triggered, at step S12, the de-duplicated slices are moved from NAND Flash to the PCM and the process ends.

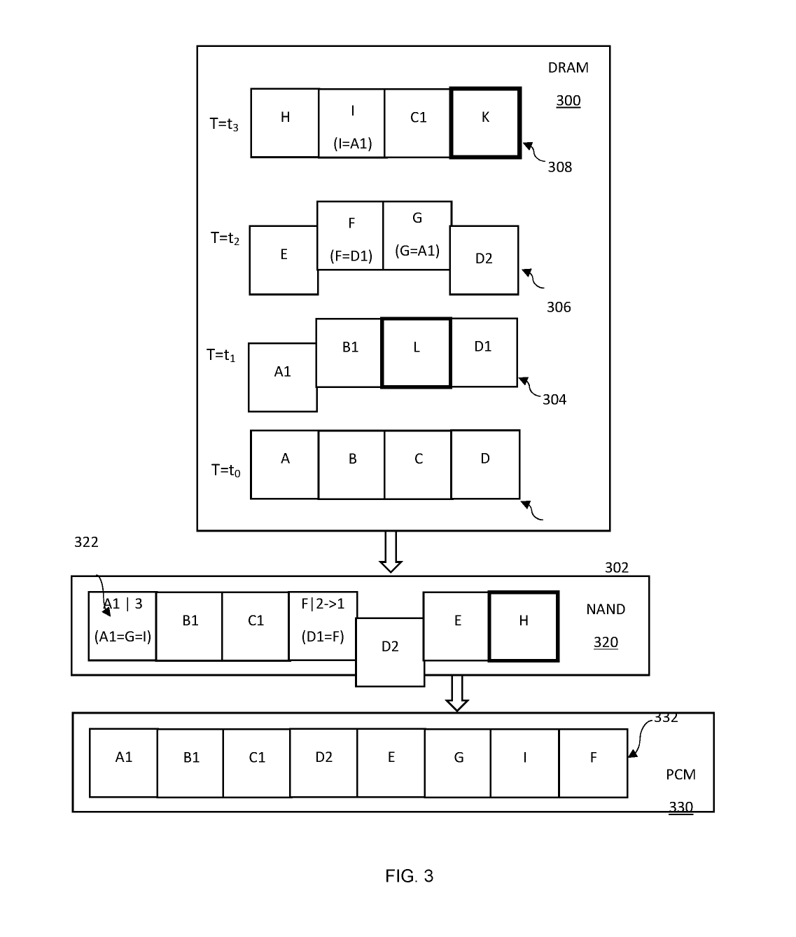

With regard to FIG. 3, an exemplary set of data slices at four different times (t₀, t₁, t₂, t₃) is depicted according to embodiments of the present invention. Initially, at time t₀, multiple data slices 302 (A, B, C, and D) are written to DRAM 300 inside a multi-chip package (MPC) integrated circuit, and the data is accessed and updated in cycles at t₁, t₂, t₃. At t₁, data slices 304 (A1, B1, L, and D1) are received by DRAM 300. A1, B1, and D1 are new versions of A, B and D, respectively. L is a new slice with a very short lifespan, and C is still valid. At time t₂, L has expired and data slices 306 (E, F, G, and D2) are received by DRAM 300. E is a new slice, F is a new slice with the same content as D1, G has the same content as A1, and D2 is an updated version of D1. D2 replaces D1, but because new slice F has the same content as D1, the content of D1 is saved to be used for slice F. At time t₃, data slices 308 (H, I, C1, and K) are received by DRAM 300. H is a new slice, I is the same as A1, C1 is an updated version of C, and K is a new slice with a very short lifespan. Because the lifespan of slice K is very short, K expires and will not be written into the next of the data buffer (e.g., NAND 320).

After time t₃, valid data is copied from DRAM 300 to 3D SLC NAND 320. The system determines that A1, B1, C1, F, D2, E, G, H, and I are valid data slices, and A1, G, and I have the same content. K and L have expired, and other slices have been updated to new versions. Further, hash calculations and comparisons are performed on the fly. When the system determines that F and D1 have the same content, slice D1 is marked twice in metadata. When D1 is updated by D2, D2 and F subsequently contain different content. Therefore, new slice D2 is inserted. The original metadata is modified to indicate that D1 and F no longer share content because D1 is invalid. The system also determines that G and I are duplicate slices and the duplicate slices are not written to 3D SLC NAND 320.

Data in 3D SLC NAND 320 may also receive updates or expire after a certain time. When updates are received by 3D SLC NAND 320, the new data is appended after the write location. The corresponding old or expired slice is marked as invalid and will not be written into the next tier (e.g., PCM 330). For example, slice H terminates while it is stored in 3D SLC NAND 320 and will not be written to PCM 330. According to some embodiments, 3D SLC NAND 320 is written using a log-structure, where the write pointer changes incrementally and returns to an initial address when the write pointer reaches a maximum value. Valid data is eventually moved from 3D SLC NAND 320 to PCM 330. The format of the data is converted and individual memory space is assigned for duplicated slices. Converting the data format reduces access latency, especially for read intensive operations.

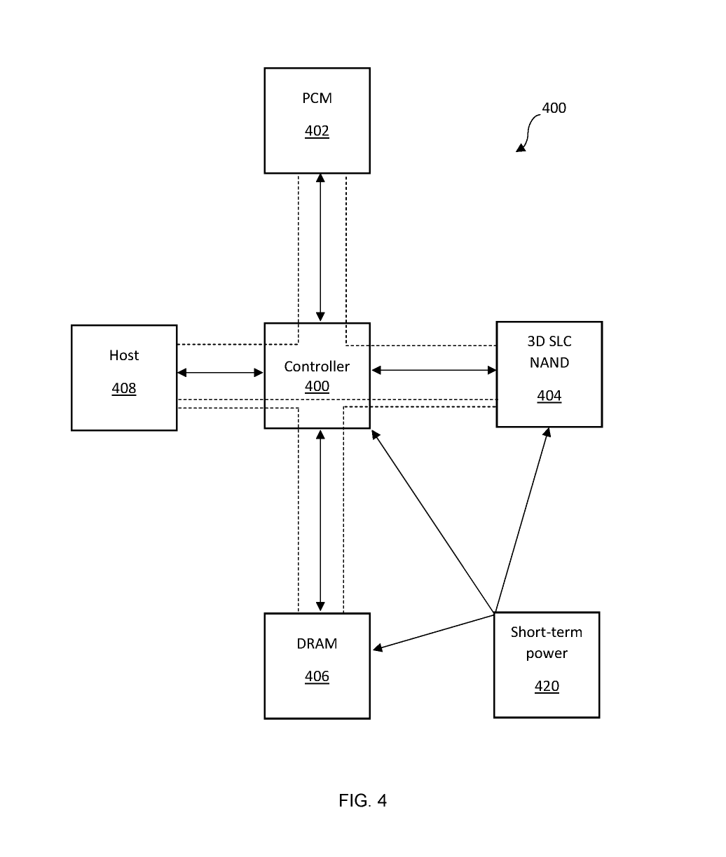

With regard to FIG. 4, an exemplary data flow 400 for a memory system operating in a read mode, a write mode, and a power failure mode is depicted according to embodiments of the present invention. The data flow for a read operation varies depending on where the data is stored. For data that is in PCM 402, the data is read directly from PCM 402 to host 408 using controller 400. The latency for this operation is similar to or the same as accessing DRAM. When data is in DRAM 406, it is retrieved directly from DRAM 406 to host 408. When valid data is stored in 3D SLC NAND 404, the data is read using high-throughput SLC. To further accelerate the read operation, DRAM 406 can be used as a read cache for 3D SLC NAND 404 to host frequently accessed “hot” data. In this regard, DRAM performs two functions: accumulating chunks of data and serving as a read cache for 3D SLC NAND 404.

When the memory system operates in a write mode, the tiered ordering of DRAM, NAND, and PCM is followed. Controller 400 synchronizes DRAM 406, 3D SLC NAND 404, and PCM 402. When data is updated, regardless of where the old data is located, the new version of the data is stored in DRAM 406 and controller 400 marks all other versions stored in any tier as invalid. For a data slice with a long enough lifespan, the data slice will eventually be moved through all three tiers, eventually being stored in non-volatile PCM 402.

In a power failure scenario, where a power supply suddenly and unexpectedly malfunctions, for example, a short-term power module 420 is used to provide power for writing data from DRAM 406 to 3D SLC NAND 404. 3D SLC NAND 404 is non-volatile and the SLC enables fast write operations. When normal power is restored to the memory system, the DRAM data written into 3D SLC NAND 404 is loaded and the memory system continues normal operation, for example, using the exemplary sequence of computer-implemented steps illustrated in FIG. 2.

According to some embodiments, the memory system effectively comprises 16 GB of useable server memory. Specifically, the memory system comprises 64 MB DRAM, 16 GB 3D NAND Flash, and 16 GB PCM. The chunk size may be set to 4 MB, and the slice size may be set at 16 KB. 3D SLC NAND Flash is programmed by writing multiple chunks (e.g., four chunks), where flash is written to once every 1 ms in the worst case. The time interval between write operations may be adjusted. Data is flushed from 3D SLC NAND Flash to PCM once every 30 seconds. In this exemplary configuration, the useful lifespan of the PCM is approximately 3450 days. Therefore, PCMs endurance is greatly improved over traditional implementations and may be used as server memory with non-volatility, which DRAM cannot offer.

Embodiments of the present invention are thus described. While the present invention has been described in particular embodiments, it should be appreciated that the present invention should not be construed as limited by such embodiments, but rather construed according to the following claims.

What is claimed is:

1. A memory system, comprising:
a memory controller;
a first storage tier coupled to the memory controller, comprising DRAM;
a second storage tier coupled to the memory controller, comprising flash memory; and
a third storage tier coupled to the memory controller, comprising phase change memory,
wherein new data to be written to the memory system is written to DRAM, the new data and subsequent data are merged to generate a data chunk, the data chunk is divided into a plurality of data slices, a hash value is calculated for a data slice of the plurality of data slices, the data slice is written to flash memory when the calculated hash value for the respective data slice does not exist in a hash library, and a plurality of data slices written to the flash memory are written from the flash memory to the phase change memory.

2. The memory system of claim 1, wherein the memory controller waits a preset period of time before writing the data slices to the phase change memory

3. The memory system of claim 1, wherein the flash memory comprises 3D SLC NAND Flash.

4. The memory system of claim 1, wherein the memory controller identifies valid data slices of the data slices and writes only the valid data slices from the flash memory to the phase change memory.

5. The method of claim 4, wherein the memory controller identifies data slices that have expired and data slices that have been updated.

6. The memory system of claim 1, wherein the DRAM comprises 64 MB, the flash memory comprises 16 GB, and the phase change memory comprises 16 GB.

7. The memory system of claim 1, wherein the data chunk comprises 4 MB.

8. A method for storing data using phase change memory, comprising:
writing a first set of data to DRAM;
merging the first set of data with subsequent data to generate a data chunk;
dividing the data chunk into a plurality of data slices;
calculating a hash value for a data slice of the plurality of data slices;
determining if the hash value calculated for each respective data slice exists in a hash library;
writing the data slice to flash memory when the calculated hash value for the respective data slice does not exist in the hash library; and
writing a plurality of a plurality of data slices written to flash memory from the flash memory to the phase change memory.

9. The method of claim 8, wherein the calculating a hash value for each data slice of the plurality of data slices is performed immediately when the respective data slice is received.

10. The method of claim 8, further comprising waiting a preset period of time before writing the data slices to phase change memory.

11. The method of claim 8, wherein the writing the data slices from the flash memory to the phase change memory further comprises:
identifying valid data slices of the data slices; and
writing only the valid data slices from the flash memory to the phase change memory.

12. The method of claim 11, wherein the identifying valid data slices of the data slices further comprises:
identifying data slices that have expired; and
identifying data slices that have been updated.

13. The method of claim 8, wherein the DRAM comprises 64 MB, the flash memory comprises 16 GB, and the phase change memory comprises 16 GB.

14. The method of claim 8, wherein the data chunk comprises 4 MB.

15. A computer program product tangibly embodied in a computer-readable storage device and comprising instructions that when executed by a processor perform a method for storing data using phase change memory, the method comprising:
writing a first set of data to DRAM;
merging the first set of data with subsequent data to generate a data chunk;
dividing the data chunk into a plurality of data slices;
calculating a hash value for a data slice of the plurality of data slices;
determining if the hash value calculated for each respective data slice exists in a hash library;
writing the data slice to flash memory when the calculated hash value for the respective data slice does not exist in the hash library; and
writing a plurality of data slices written to flash memory from the flash memory to the phase change memory.

16. The method of claim 15, wherein the calculating a hash value for each data slice of the plurality of data slices is performed immediately when the respective data slice is received.

17. The method of claim 15, further comprising waiting a preset period of time before writing the data slices to phase change memory.

18. The method of claim 15, wherein the writing the data slices from the flash memory to the phase change memory further comprises:
identifying valid data slices of the data slices; and
writing only the valid data slices from the flash memory to the phase change memory.

19. The method of claim 18, wherein the identifying valid data slices of the data slices further comprises:
identifying data slices that have expired; and
identifying data slices that have been updated.

20. The method of claim 15, wherein the DRAM comprises 64 MB, the flash memory comprises 16 GB, and the phase change memory comprises 16 GB.
